(19) United States
(12) Patent Application Publication
(10) Pub. No.: US 2012/0002102 A1
(43) Pub. Date: Jan. 5, 2012

(54) CAMERA MODULE

(75) Inventor: Yoshihiro Sekimoto, Osaka (JP)

(73) Assignee: Sharp Kabushiki Kaisha, Osaka (JP)

(21) Appl. No.: 13/170,742

(22) Filed: Jun. 28, 2011

(30) Foreign Application Priority Data
Jul. 2, 2010 (JP) 2010-152363
Apr. 21, 2011 (JP) 2011-95432

(51) Int. Cl. H04N 5/225

(52) U.S. Cl. 348/374; 348/E05.024

(57) ABSTRACT

A camera module includes a lens drive device that moves an image pickup lens along an optical axis. The lens drive device has electromagnetic drive means that drives the image pickup lens by electromagnetic force with use of a coil and a magnet. The image pickup lens has a planimetrically rectangular shape. The magnet and the coil are disposed along each of at least one pair of opposite sides of the rectangular shape. By utilizing the characteristics of the image pickup lens having a rectangular shape, the magnet and coil of the lens drive device are disposed along each of the at least one pair of opposite sides. This makes it possible to provide a camera module having a lens drive device with a smaller footprint (amount of space that the camera module uses) than in the case of an arrangement of magnets at the corners of the image pickup lens.

This Nonprovisional application claims priority under 35 U.S.C. §119(a) on patent application No. 2010-152363 filed in Japan on Jul. 2, 2010, and patent application No. 2011-095432 filed in Japan on Apr. 21, 2011, the entire contents of which are hereby incorporated by reference.

### TECHNICAL FIELD

The present invention relates to camera modules that are mounted in electronic devices such as mobile phones and, in particular, to an autofocusing camera module fitted with a wafer-level lens (i.e., a lens fabricated at wafer level) and an autofocusing reflowable camera module (i.e., a camera module adapted to temperatures in a reflow environment).

### BACKGROUND ART

Most of the recent models of mobile phone incorporate camera modules. Most of the camera modules thus employed are those types of camera module which fulfill an autofocusing function through a lens drive device. There are various types of lens drive device: those types of lens drive device which use stepping motors, those types of lens drive device which use piezoelectric elements, and those types of lens drive device which use VCMs (voice coil motors), etc. These types of lens drive device are already commercially available.

Such a camera module having an autofocusing function is usually structured to include a lens drive device that serves to drive a lens, a sensor cover housing an image pickup element therein, a circuit substrate to which the image pickup element has been fixed, etc., with these components put on top of one another.

The lens used here is usually one that was separately fabricated by molding and, as such, has a substantially cylindrical shape with both its upper and lower surfaces curved in shape. Further, as an autofocusing mechanism for driving such a lens having a substantially cylindrical shape, the following structure has been proposed, for example: A voice coil motor has magnets disposed at four corners, respectively, by utilizing a space created by the difference between the rectangular shape of the actuator and the cylindrical shape of the lens (e.g., see Patent Literature 1).

In this example, there are also magnets disposed at two sides, in addition to those disposed at the four corners. However, these two magnets are not disposed by utilizing the difference from the shape of the lens, and each have an outer shape that is not completely rectangular but partially protruding. For this reason, these two magnets are disposed by utilizing this space, without any consideration given to a different lens shape.

Patent Literature 1, referenced above, describes a so-called moving-coil voice coil motor having a coil placed in a movable part and magnets disposed in a fixed part.

On the other hand, there has been proposed a so-called moving-magnet voice coil motor having magnets disposed in a movable part and coils disposed in a fixed part (e.g., see Patent Literature 5).

In this example, too, the coils disposed at four corners by utilizing a space created by the difference between the rectangular shape of the actuator and the cylindrical shape of the lens, and the magnets are disposed in the movable part to face the coils.

Meanwhile, there has been proposed an example of a moving-magnet voice coil motor similar to that of Patent Literature 5 where instead of being disposed at the four corners, the coils are disposed to face magnets disposed at four sides (e.g., see Patent Literature 6).

This example, however, does not make good use of the space created by the difference between the rectangular shape of the actuator and the cylindrical shape of the lens and, as such, does not give any consideration to a different lens shape.

Incidentally, there has recently been proposed a technique by which lenses for use in camera modules are fabricated at wafer level (e.g., see Patent Literature 2). In Patent Literature 2, which describes wafer-level fabrication, a plurality of optical-lens substrates having a large number of lens arrays formed therein are put and joined on top of one another and then cut into separate pieces with a blade. For this reason, as is clear from FIG. 4 of Patent Literature 2, each separate lens unit has a rectangular shape. It should be noted that Patent Literature 2 does not particularly mention an autofocusing function or reflow adaptation.

Meanwhile, a lens adapted to reflow has been considered for use as such a wafer-level lens (i.e., a lens fabricated at wafer level or, more specifically, a lens fabricated as a separate lens by cutting a group of lens formed in an array) (e.g., see Patent Literature 3). Patent Literature 3 renders a wafer-level lens adapted to reflow. Accordingly, Patent Literature 3 proposes using glass or a thermosetting resin material as a material for lens substrates. However, Patent Literature 3 does not particularly mention an autofocusing function.

Furthermore, a study has been conducted of a camera module adapted to reflow and including a lens drive mechanism having functions such as an autofocusing function, etc. (e.g., see Patent Literature 4). Patent Literature 4 names a servo motor, a stepping motor, a solenoid, etc. as an actuator for driving the lens, but does not describe any specific structure.

### Citation List

Patent Literature 1

Japanese Patent Application Publication, Tokukai, No. 2008-299103 A (Publication Date: Dec. 11, 2008)

Patent Literature 2

Japanese Patent Application Publication, Tokukai, No. 2008-129606 A (Publication Date: Jun. 5, 2008)

Patent Literature 3

Japanese Patent Application Publication, Tokukai, No. 2010-54810 A (Publication Date: Mar. 11, 2010)

Patent Literature 4

Japanese Patent Application Publication, Tokukai, No. 2009-204721 A (Publication Date: Sep. 10, 2009)

Patent Literature 5

Japanese Patent Application Publication, Tokukai, No. 2011-039481 A (Publication Date: Feb. 24, 2011)

Patent Literature 6

Japanese Patent Application Publication, Tokukai, No. 2009-069611 A (Publication Date: Apr. 2, 2009)

### SUMMARY OF THE INVENTION

### Technical Problem

With advances in the development of wafer-level lenses and improvements in their performance, there has been a growing demand for wafer-level lenses to be employed in high-resolution camera modules. It is desirable that high-resolution camera modules employing wafer-level lenses be fitted with an autofocusing function.

As mentioned above, there are various types of autofocusing mechanism for achieving an autofocusing function: those types of autofocusing mechanism which use stepping motors, those types of autofocusing mechanism which use piezoelectric elements, those types of autofocusing mechanism which use VCMs, etc. Among then, those types of autofocusing mechanism which use VCMs hold an overwhelming majority of autofocusing mechanisms. Therefore, it is most desirable that autofocusing mechanisms fitted with wafer-level lenses be able to use VCMs.

However, if a VCM of Patent Literature 1 is fitted with a rectangular lens of Patent Literature 2, the magnets disposed at the four corners causes an increase in size of the camera module (i.e., an increase in footprint (amount of space that the camera module uses).

Similarly, Patent Literatures 5 and 6, which do not give any consideration to a rectangular lens, do not suggest anything about how the magnets and the coils are disposed when the VCM is fitted with a rectangular lens.

Further, even if fitted with a lens of Patent Literature 3 adapted to reflow, a conventional VCM used as is will deteriorate in performance due to reflow during manufacture, because a rise in temperature to a reflow temperature causes irreversible permanent thermal demagnetization in the magnets. Specifically, there will be a decrease in magnetic flux density after reflow and, therefore, a decrease in thrust of the VCM.

Furthermore, although Patent Literature 4 mentions reflow adaptation, it does not mention demagnetization of the magnets.

The present invention has been made in view of the foregoing conventional problems, and it is an object of the present invention to provide a camera module with a smaller footprint and, furthermore, to provide a camera module with consideration given to reflow adaptation.

### Solution to Problem

In order to solve the foregoing problems, a camera module of the present invention is a camera module including: an optical section having an image pickup lens and a lens-retaining member that retains the image pickup lens; a lens drive section that moves the image pickup lens along an optical axis; a holder section, contained in the lens drive section, which holds the lens-retaining member therein and which is movable along the optical axis with respect to a fixed part of the lens drive section; an image pickup element that converts, into an electrical signal, light having entered the image pickup element through the image pickup lens; and a substrate section on which the image pickup element has been mounted, the lens drive section having electromagnetic drive means that drives the image pickup lens by electromagnetic force with use of a magnet and a coil, the image pickup lens having a planimetrically rectangular shape, the magnet and the coil being disposed along each of at least one pair of opposite sides of the rectangular shape.

According to the foregoing invention, by utilizing the characteristics of the image pickup lens having a rectangular shape, the magnet and coil of the lens drive device are disposed along each of the at least one pair of opposite sides. This makes it possible to provide a camera module having a lens drive device with a smaller footprint (amount of space that the camera module uses) than in the case of an arrangement of magnets at the corners of the image pickup lens.

### Advantageous Effects of Invention

In the camera module of the present invention, as described above, the lens drive device has electromagnetic drive means that drives the image pickup lens by electromagnetic force with use of a coil and a magnet; the image pickup lens has a planimetrically rectangular shape; and the magnet and the coil are disposed along each of at least one pair of opposite sides of the rectangular shape.

This brings about an effect of providing a camera module with a smaller footprint. This further brings about an effect of providing a camera module with consideration given to reflow adaptation.

### BRIEF DESCRIPTION OF DRAWINGS

FIG. 1 is a plan view showing the shapes of an image pickup lens, a lens barrel, and a lens holder in a camera module according to an embodiment of the present invention.

FIG. 2 is a perspective view of an image pickup lens according to an embodiment of the present invention.

FIG. 3 is a perspective view of a camera module according to an embodiment of the present invention.

FIG. 4 is a cross-sectional view of the camera module of FIG. 3 taken along the line A-A.

FIG. 5 is a perspective view of a camera module according to another embodiment of the present invention.

FIG. 6 is a diagram equivalent to a cross-sectional view taken along the line B-B of FIG. 4 in a camera module according to another embodiment of the present invention.

FIG. 7 is a cross-sectional view equivalent to FIG. 4 in a camera module according to still another embodiment of the present invention.

FIG. 8 is a perspective view showing a positional relationship between magnets, a yoke, and a coil according to an embodiment of the present invention.

FIG. 9 is a side view showing a positional relationship between magnets, a yoke, and a coil according to an embodiment of the present invention.

FIG. 10 is a graph for explaining a relationship between a demagnetization curve of a magnet and a permeance coefficient in an embodiment of a conventional invention and an embodiment of the present invention.

FIG. 11, explaining arrangements of magnets in camera modules according to an embodiment of the present invention, includes (a) a plan view showing the side arrangement of a planimetrically triangular magnet along each side of a planimetrically rectangular image pickup lens in a camera module according to an embodiment of the present invention, (b) a plan view showing the corner arrangement of planimetrically triangular magnets at the (four) corners of a planimetrically rectangular image pickup lens in a conventional camera module, (c) a plan view showing the side arrangement of planimetrically rectangular magnets along a pair of opposite sides of a planimetrically rectangular image pickup lens in a camera module according to an embodiment of the present invention, and (d) a plan view showing the corner arrangement of planimetrically rectangular magnets at two opposite corners of a planimetrically rectangular image pickup lens in a conventional camera module.

FIG. 12 is a cross-sectional view showing lens barrel height positioning means according to an embodiment of the present invention.

FIG. 13 is a plan view showing the shapes of an image pickup lens, a lens barrel, and a lens holder in a camera module according to another embodiment of the present invention.

FIG. 14 is a plan view showing the shapes of an image pickup lens, a lens barrel, and a lens holder in a camera module according to still another embodiment of the present invention.

### DESCRIPTION OF EMBODIMENTS

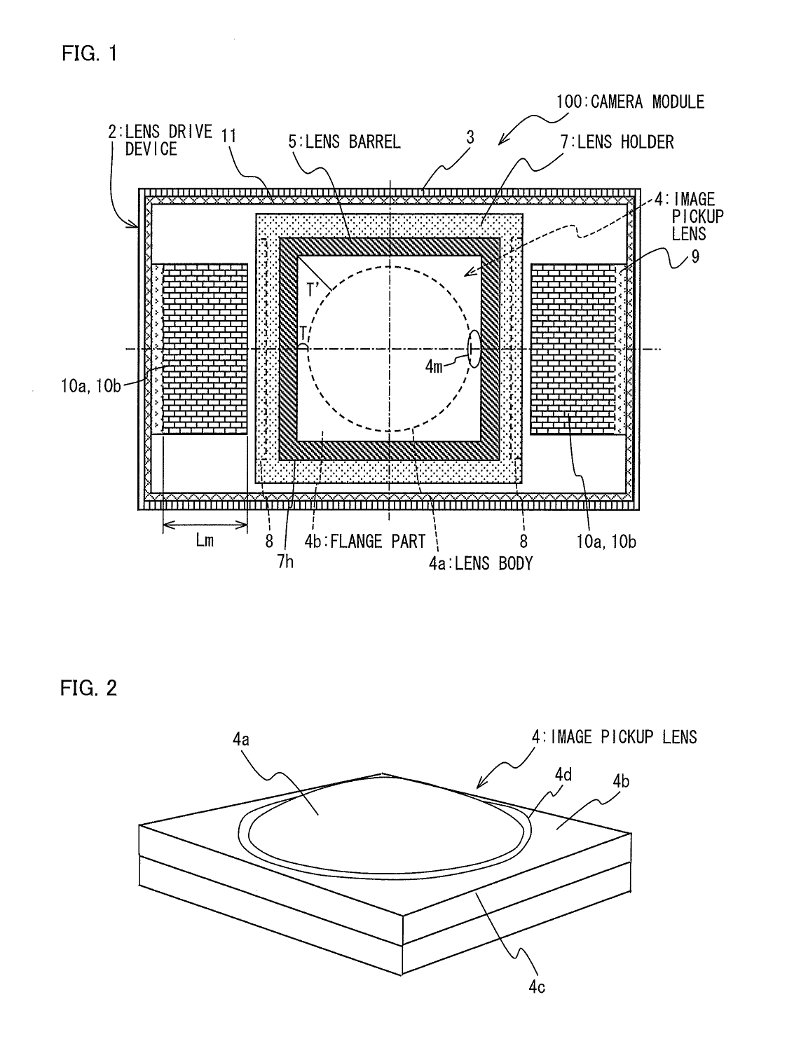

An embodiment of the present invention is described below with reference to FIGS. 1 through 14.

### Camera Module according to a First Embodiment

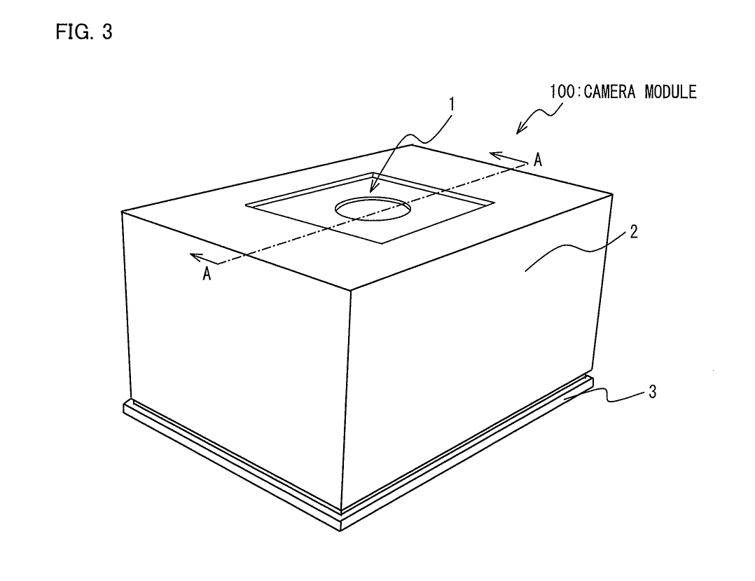

FIG. 3 is a perspective view of a camera module 100 of the present embodiment. The camera module 100 includes an optical section 1, which is an image pickup optical system; a lens drive device 2 (lens drive section), which serves to drive the optical section 1; and a substrate section 3, on a surface of which or partially in which an image pickup element and its surrounding circuit components have been mounted, the image pickup element serving to make a photoelectric conversion of light having traveled through the optical section 1.

The optical section 1 has an image pickup lens 4 and a lens barrel 5 (lens-retaining member) and is retained in the lens drive device 2. It should be noted that the image pickup lens 4 and the lens barrel 5 will be described later. The camera module 100 is configured with the lens drive device 2 put on the substrate section 3. The following description assumes that the optical section 1 is in a higher position and the substrate section 3 is in a lower position.

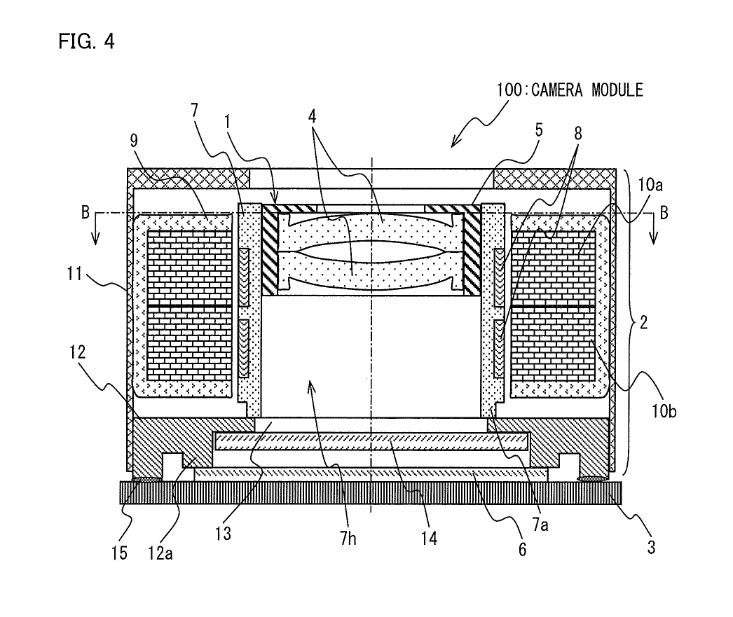

The overall structure of the camera module 100 is described here with reference to FIG. 4. FIG. 4 is a cross-sectional view of the camera module of FIG. 3 taken along the line A-A, as would be obtained by so cutting the camera module 100 in the center that the resulting cross-section is parallel to the direction of extension of the optical axis. It should be noted that the lens drive device 2 has electromagnetic drive means that drives the image pickup lens 4 by electromagnetic force with use of magnets 10a and 10b and a coil 8 and is generally called a voice coil motor (VCM).

The optical section 1 is an image pickup optical system that forms a subject image, and guides outside light to an image pickup element 6 on the substrate section 3. The optical section 1 has an image pickup lens 4 obtained by joining plural (two in FIG. 1) lenses on top of each other and a lens barrel 5 that retains the image pickup lens 4. The lens barrel 5 is fixed to a lens holder 7 (holder section) inside of the lens drive device 2. The optical axis of the image pickup lens 4 and the center of axle of the lens barrel 5 coincide with each other.

The lens drive device 2 drives the optical section 1 along the optical axis by electromagnetic force. That is, the lens drive device 2 moves up and down the image pickup lens 4 (i.e., drives the image pickup lens 4 along the optical axis) between an end at infinity and a macro end. This allows the camera module 100 to fulfill an autofocusing function.

It should be noted that the term “end at infinity of the image pickup lens 4” means a position where the image pickup lens 4 are focused on the subject at infinity, and that the term “macro end of the image pickup lens 4” means a position where the image pickup lens 4 are focused on the subject at a desired macro distance (e.g., 10 cm).

The lens drive device 2 includes a movable part, which, in driving the image pickup lens 4, moves along the optical axis to move the optical section 1 (image pickup lens 4) along the optical axis; and a fixed part, which does not change in position even while the image pickup lens 4 are being driven. The movable part is housed in the fixed part. The movable part has a lens holder 7 and a coil 8 (electromagnetic drive means), and the fixed part has a yoke (electromagnetic drive means) 9, magnets (permanent magnets, electromagnetic drive means) 10a and 10b, a cover 11, and a base 12 (base member).

Although, in FIG. 4, the yoke 9 has its side surface provided on a side surface of the cover 11, the yoke 9 may be used as a side surface part of the cover 11 and the cover 11 may have its top surface part made of a resin, etc. Alternatively, the cover 11 may be made of a metal to play a role as a shield case to eliminate or reduce the influence of electromagnetic noise. In this case, it is desirable that part of the cover 11 serving as a shield case be electrically connected to the ground (i.e., be electrically grounded).

The lens drive device 2 is configured, specifically, such that the lend holder 7 holding the lens barrel 5 therein is housed in a space formed by the base 12 and the cover 11.

The lens holder 7 holds therein the lens barrel 5 retaining the image pickup lens 4. The lens barrel 5 and the lens holder 7 are both hollow (cylindrical) members.

In the present embodiment, the lens barrel 5 has its outside surface unthreaded, i.e., flat, and the lens holder 7 has its inside surface unthreaded, i.e., flat. Further, it is possible to form a depression in either the lens barrel 5 or the lens holder 7 or to form depressions in both the lens barrel 5 and the lens holder 7 in order to increase the strength of adhesion between the lens barrel 5 and the lens holder 7. In the present embodiment, since the outside surface of the lens barrel 5 and the inside surface of the lens holder 7 are unthreaded, focus adjustments are made by sliding the lens barrel 5 across the lens holder along the optical axis (Note that the lens barrel 5 can slide inside of the lens holder 7 in which the lens barrel 5 has been mounted). An assembled structure that dispenses with focus adjustments by improving the precision of components will be described as a third embodiment later. Further, the reason why the outside surface of the lens barrel 5 and the inside surface of the lens holder 7 are unthreaded will be mentioned later.

Next, the shapes of the image pickup lens 4, of the lens barrel 5, and of the lens holder 7 are described with reference to FIGS. 1 and 2.

FIG. 1 is a plan view showing the shapes of the image pickup lens 4, lens barrel 5, and lens holder 7 in the camera module 100 of the present embodiment. As shown in the plan view of FIG. 1, the lens barrel 5 and the lens holder 7 are planimetrically rectangular, because as shown in the plan view of FIG. 1 and the perspective view of FIG. 2 the outer shape of the image pickup lens 4 is rectangular. The magnets 10a and 10b and the coil 8 are disposed along each of at least one pair of opposite sides of the rectangular shape of the image pickup lens 4. More specifically, the magnets 10a and 10b and the coil 8 are disposed only at each of a pair of opposite sides of the rectangular shape of the image pickup lens 4.

The image pickup lens 4 is one obtained by putting on top of each other a plurality of large sheets made of glass, etc. with a large number of lens shapes formed thereon and then cutting the sheets into separate pieces by dicing. The dicing of the sheets is not limited to being carried out after the sheets have been put on top of each other. Instead, a sheet may be diced without being put on top of another sheet.

The image pickup lens 4 has a lens body 4a (lens part) in the center and a flange part 4b surrounding the lens body 4a. The outer shape of the lens body 4a is planimetrically substantially circular (preferably circular). Since the image pickup lens 4 is one separately cut out by dicing, the flange part 4b has an outer perimeter 4c that is rectangular and an inner perimeter 4d that is substantially circular (or circular).

Further, in the case of lenses put on top of each other, the lenses are joined with an adhesive at the flange part 4b after being put on top of each other. This makes it necessary for the flange part 4b to have a predetermined area for greater adhesion strength.

In the image pickup lens 4 of the present embodiment, the difference in area between the planimetrically substantially circular outer shape of the lens body 4a and the planimetrically rectangular outer shape of the flange part 4b surrounding the lens body 4a is utilized. The area of the flange part 4b can be secured diagonally (at the four corners of the image pickup lens 4). Further, the thickness T of a site 4m of the flange part 4b at a midpoint of each of the four sides in the outer perimeter 4c as viewed planimetrically can be made thinner than the thickness T′ of each of the four corners of the flange part 4b as viewed planimetrically.

In the manufacture of the image pickup lens 4 of the present embodiment, dicing is carried out so that the difference between the area of the lens body 4a as viewed planimetrically and the area of the flange part 4b as viewed planimetrically can be minimized. This makes it possible to minimize the outer size of the image pickup lens 4 per se and secure an area necessary for adhesion at the four corners of the flange part 4b located diagonally in the image pickup lens 4. This in turn makes it possible to both reduce the outer size and secure an adhesion area (i.e., secure adhesion strength).

In this way, the image pickup lens 4 allows the thickness T of a site 4m of the flange part 4b at a midpoint of each of the four sides in the outer perimeter 4c as viewed planimetrically to be narrower than in a conventional image pickup lens 4. This makes it possible to add, to an area in which the magnets 10a and 10b are disposed, a space created to the extent that the thickness T has been narrowed.

Therefore, because, in the camera module 100 of the present embodiment, the thickness Lm of each of the magnets 10a and 10b can be made thicker than in a conventional camera module, it becomes easier to take measures to adapt to temperatures in a reflow environment, as will be mentioned later.

In FIG. 1, the size of a hole 7h inside of the lens holder 7 is made slightly larger than the outer size of the lens barrel 5, so that the lens barrel 5 is mounted in the middle of the lens holder 7. The center of axle of the lens holder 7 coincides with the optical axis of the image pickup lens 4 and the center of axle of the lens barrel 5. Since the outer shape of the lens barrel 5 and the shape of the hole 7h of the lens holder 7 are rectangular, it is impossible (or difficult) to employ a structure for height adjustment with a screw, although such structures have been widely employed in conventional camera modules. However, since the lens barrel 5 can slide inside of the lens holder 7, it is possible to adjust the height of the lens barrel 5 without providing a screw.

After the lens barrel 5 has been mounted, the position (height) of the lens barrel 5 along the optical axis is adjusted, and then the lens holder 7 and the lens barrel 5 are fixed with an adhesive, etc. It is preferable that the adhesive used be for example a thermosetting UV adhesive or an anaerobic UV adhesive. The reason why the position of the lens barrel 5 along the optical axis is adjusted will be mentioned later.

The lens holder 7 has a peripheral end to which the coil has been fixed. Meanwhile, the yoke 9 has an inside surface to which the magnets 10a and 10b have been fixed to face the coil 8. In this way, the yoke 9 and the magnets 10a and 10b constitute a magnetic circuit.

The base 12, which constitutes a bottom part of the lens drive device 2, serves also as a sensor cover that surrounds the image pickup element 6. Such a configuration of integration of the base and the sensor cover makes it possible to reduce the number of components and prevent deterioration in height precision due to stacking of components. The base 12 has an opening 13 in the middle for securing a light path.

The lens drive device 2 drives the image pickup lens 4 along the optical axis by electromagnetic force generated by the coil 8 and the magnets 10a and 10b. Specifically, the present embodiment passes an electric current through the coil 8, which is located in a magnetic field formed by the magnets 10a and 10b. Force (electromagnetic force) generated by passing the electric current makes it possible to drive the lens holder 7 along the optical axis. This in turn makes it possible to drive the image pickup lens 4, housed in the lens holder 7, along the optical axis.

Further, in the lens drive device 2 of the present embodiment, there are provided plate springs (not illustrated) on upper and lower surfaces (top surface and bottom surface) of the lens holder 7, with the movable part supported movably along the optical axis. It should be noted that with the camera module 100 assembled as shown in FIG. 4, while a protrusion 7a, formed on the bottom surface of the lens holder 7, is in contact with the base 12, the lens holder 7 is under downward pressurization by the elastic force of the plate springs. The position where the lens holder 7 is in contact with the base 12 as shown in FIG. 4 is a mechanical end position at infinity. In the mechanical end position at infinity, the position of the image pickup lens 4 along the optical axis needs to be adjusted so that the image pickup lens 4 are focused on the subject at infinity. The method of adjustment is as described above; that is, the position of the image pickup lens 4 along the optical axis is adjusted by adjusting the position of the lens barrel 5 along the optical axis.

The image pickup element 6 is an element that converts, into an electrical signal, a subject image formed by the lens drive device 2. That is, the image pickup element 6 is a sensor device that converts, into an electrical signal, light received though the image pickup lens 4 of the lens drive device 2.

The image pickup element 6 is for example a CCD (charge-coupled device) or CMOS (complementary metal-oxide-semiconductor) sensor IC. The image pickup element 6 has a light-receiving section (not illustrated) formed on a surface thereof, and the light-receiving section has a plurality of pixels disposed in a matrix manner. The light-receiving section is a region that forms an image of light coming from the lens drive device 2 and, as such, can also be called a pixel area.

The image pickup element 6 converts, into an electrical signal, a subject image formed by forming an image of light having entered the light-receiving section (i.e., light having entered the pixel area), and outputs the electrical signal as an analog image signal. That is, a photoelectric conversion is carried out in the light-receiving section. The operation of the image pickup element 6 is controlled by a DSP (digital signal processor; not illustrated), and the image signal generated by the image pickup element 6 is processed by the DSP.

The substrate section 3 has a patterned wire (not illustrated). This wire electrically connects the substrate section 3 and the image pickup element 6 to each other. The substrate section 3 is for example a printed circuit board or a ceramic substrate. The substrate section 3 is also fitted with circuit components (not illustrated) that surround the image pickup element 6, and the circuit components may be mounted on a surface of the substrate section 3 or built in the substrate section 3.

In this way, the light having entered the image pickup element 6 is subjected to a photoelectric conversion into an electrical signal, and the electrical signal is then inputted to a control circuit (not illustrated; e.g., the DSP), etc. through the substrate section 3 and taken out as an image signal in the control circuit.

Provided on a surface of the base 12 which faces the image pickup element 6 is an IR cut filter 14. Further formed on a lower surface of the base 12 is a raised portion 12a that forms a reference plane which makes contact with an upper surface of the image pickup element 6.

In this way, the present embodiment employs a chip-mounting structure in which the lens drive device 2 is mounted directly on the surface of the image pickup element 6. That is, the present embodiment is configured with the image pickup element 6 placed on the substrate section 3 and with the lens drive device 2 placed directly on the image pickup element 6.

The height of the lens drive device 2 thus mounted is determined by the height of the raised portion 12a in contact with the upper surface of the image pickup element 6. For this reason, there is provided a narrow gap below the base 12, i.e., between the base 12 and the substrate section 3, with an adhesive 15 provided to fill the gap.

The camera module 100 of the present embodiment employs the aforementioned chip-mounting structure, whereby the lens barrel 5 and the image pickup lens 4 are mounted with the base 12 and the lens holder 7 between (i) the lens barrel 5 and the image pickup lens 4 and (ii) the chip surface. This makes it possible to mount the image pickup lens 4 at a lower tilt to the image pickup element 6 with no influence, etc. of warpage of the substrate section 3.

In particular, in the case of an after-mentioned scheme that positions the image pickup lens 4 with component precision alone without adjusting the height position of the image pickup lens 4, the structure becomes effective for the tilt and also becomes greatly effective for improving the precision of the height position.

### Camera Module according to a Second Embodiment

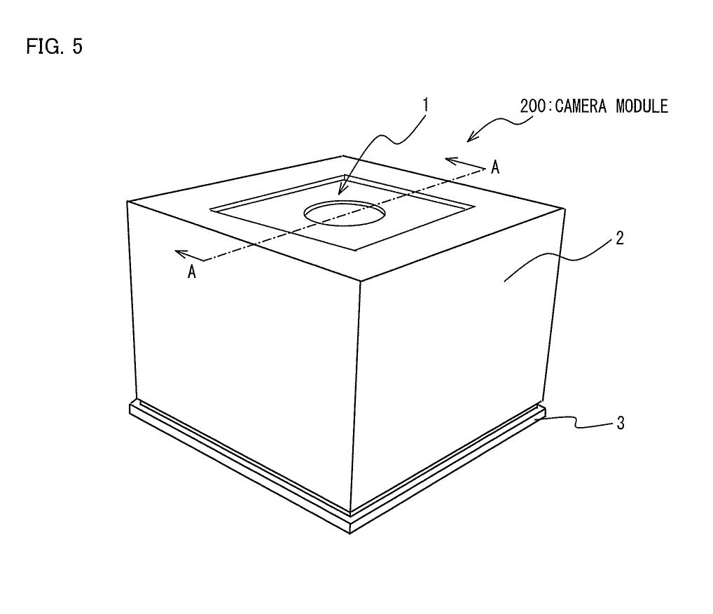

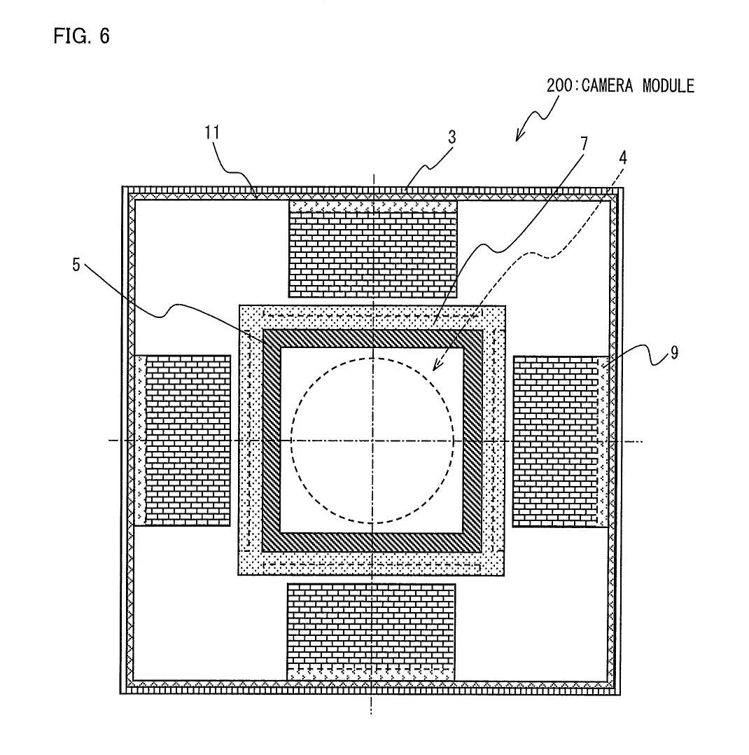

Next, another embodiment of the present invention is described with reference to FIGS. 5 and 6.

FIG. 5 is a perspective view of a camera module 200 of the present embodiment. The structure of the camera module 200 as seen in a cross-sectional view taken along the line A-A of FIG. 5 is identical to the structure of FIG. 4 and, as such, is not described here. Further, FIG. 6 is a diagram equivalent to a cross-sectional view taken along the line B-B of FIG. 4 in the camera module 200 of the present embodiment. Members having the same functions as those shown in FIGS. 3 and 4 are given the same reference numerals for description.

The camera module 100 of FIG. 4 and the camera module 200 of FIG. 6 differ from each other in that the camera module 100 of FIG. 4 has yokes 9 disposed along two sides of the rectangular image pickup lens 4 and, on the other hand, the camera module 200 of FIG. 6 has a yoke 9 disposed along each of the four sides (two pairs of opposite sides) of the rectangular image pickup lens 4.

The camera module 200 of FIG. 6 has dead spaces in the corners and therefore is more disadvantageous in footprint (amount of space the camera module uses) than the camera module of FIG. 2, but is capable of saving more space than a structure having yokes 9 respectively disposed at the four corners.

Further, since the number of places of generation of thrust is four, a higher level of thrust can be achieved. Further, as shown in FIG. 5, the projected shape of the camera module 200 is substantially square, as with a conventional camera module having four places of generation of thrust.

### Camera Module according to a Third Embodiment

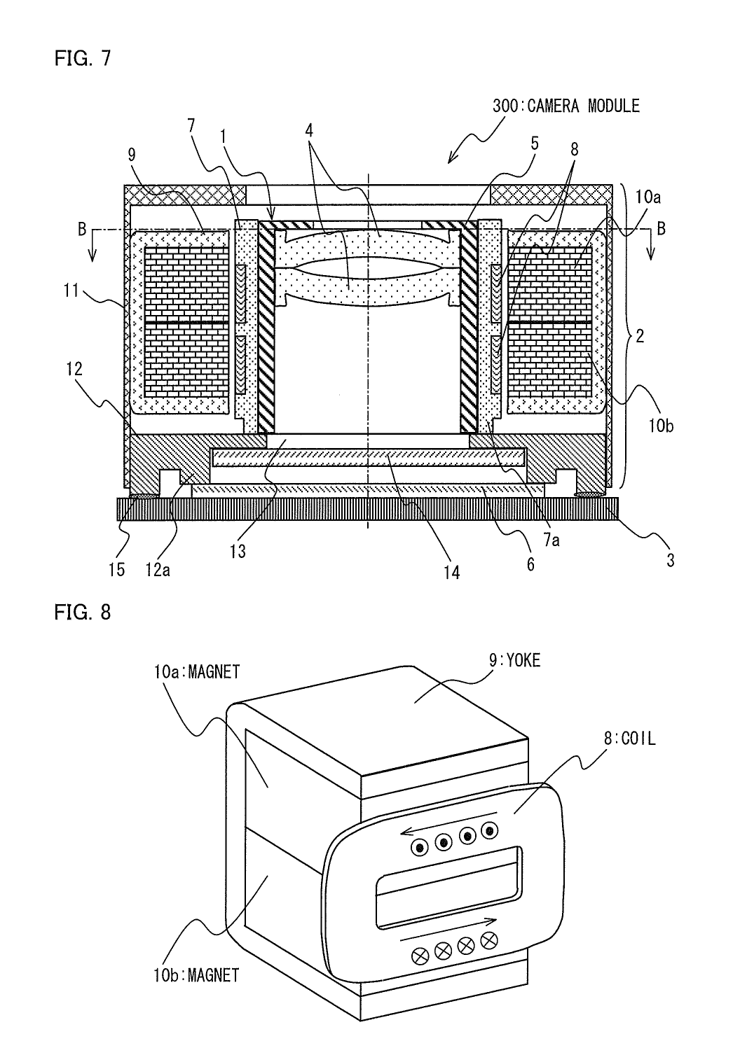

Next, still another embodiment of the present invention is described with reference to FIG. 7.

FIG. 7 is a cross-sectional view equivalent to FIG. 4 in a camera module 300 of the present embodiment. Members having the same functions as those shown in FIG. 4 are given the same reference numerals for description.

The camera module 300 of FIG. 7 differ from the camera module 100 of FIG. 4 in terms of the shape of the lens barrel 5 and the structure for mounting the lens barrel 5 to the lens holder 7. The present embodiment employs an assembled structure that dispenses with focus adjustments by improving the precision of components.

In the present embodiment, with the lens holder 7 positioned at the mechanical end at infinity, the lens barrel 5 is also in contact with the base 12 and, in such a state, the lens barrel 5 is fixed to the lens holder 7 with an adhesive. The image pickup lens 4 is either so mounted in the lens barrel 5 with high precision as to be focused in this state, or incorporated in such a position, in anticipation of a minor error in mounting, as to be focused in a position to which the image pickup lens 4 has been slightly stroked. The base 12, as in FIG. 4, is placed directly on the image pickup element 6 for higher precision. Because it is only necessary to employ a structure in which the lens barrel 5 makes contact with the base 12 and then appropriately adjust the position in which to mount the image pickup lens 4, it becomes unnecessary to carry out a focus adjustment step and therefore possible to reduce processing cost.

### Camera Module according to Fourth Embodiment

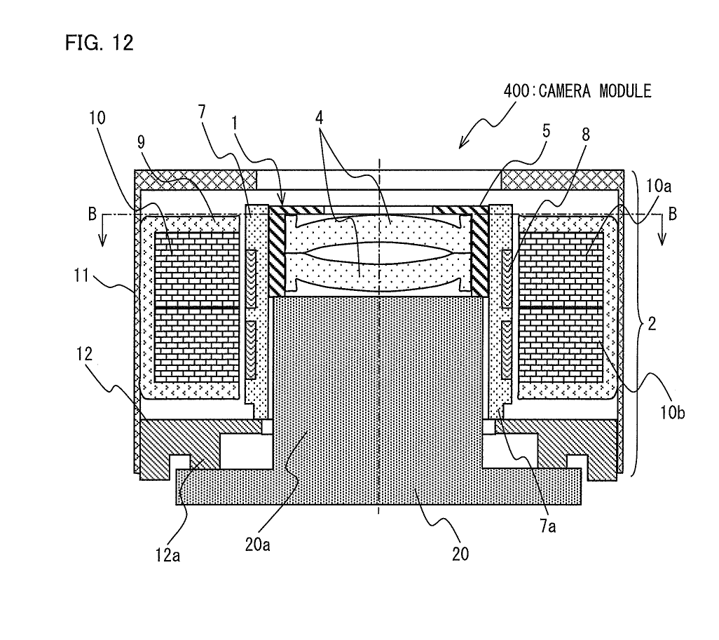

Next, still another embodiment of the present invention is described with reference to FIG. 12.

FIG. 12 is a cross-sectional view equivalent to FIG. 4 in a camera module 400 of the present embodiment. Members having the same functions as those shown in FIG. 4 are given the same reference numerals for description.

FIG. 4 shows a completed camera module. On the other hand, FIG. 12 is a cross-sectional view of a lens barrel positioned in the process of assembly.

It is assumed in the camera module 100 of FIG. 4 that the lens barrel 5 is fixed after sliding it inside of the lens holder 7 and thereby finding an optically optimum position.

In the camera module 400 of FIG. 12, on the other hand, the lens barrel 5 is positioned heightwise by using a jig.

FIG. 12 shows a camera module in which the IR cut filter 14, the image pickup element 6, the substrate section 3, etc. are yet to be fixed onto a bottom surface of the lens drive device 2, with the lens drive device 2 mounted not on these components but on a height positioning jig 20.

The height positioning jig 20 includes a projecting portion 20a. The projecting portion 20a has its height set so that the lens barrel 5 can be positioned at a predetermined height by bringing the lens barrel 5 into contact with an upper surface of the projecting portion 20a.

By fixing the lens barrel 5 to the lens holder 7 with an adhesive (not illustrated) with the lens barrel 5 thus positioned, the lens barrel 5 is fixed with its position determined with high precision.

Then, the height positioning jig 20 is removed, and the

IR cut filter 14 is fixed onto the bottom surface of the lens drive device 2. As the IR cut filter 14 is fixed, the lens drive device 2 and the substrate section 3 are adhesively fixed in such a state that the raised portion 12a of the base 12 of the lens drive device 2 is in contact with the upper surface of the image pickup element 6 mounted on the substrate section 3, whereby a camera module of the present embodiment is obtained.

[Structure of a Coil, a Yoke, and Magnets and Adaptation to Temperatures in a Reflow Environment]

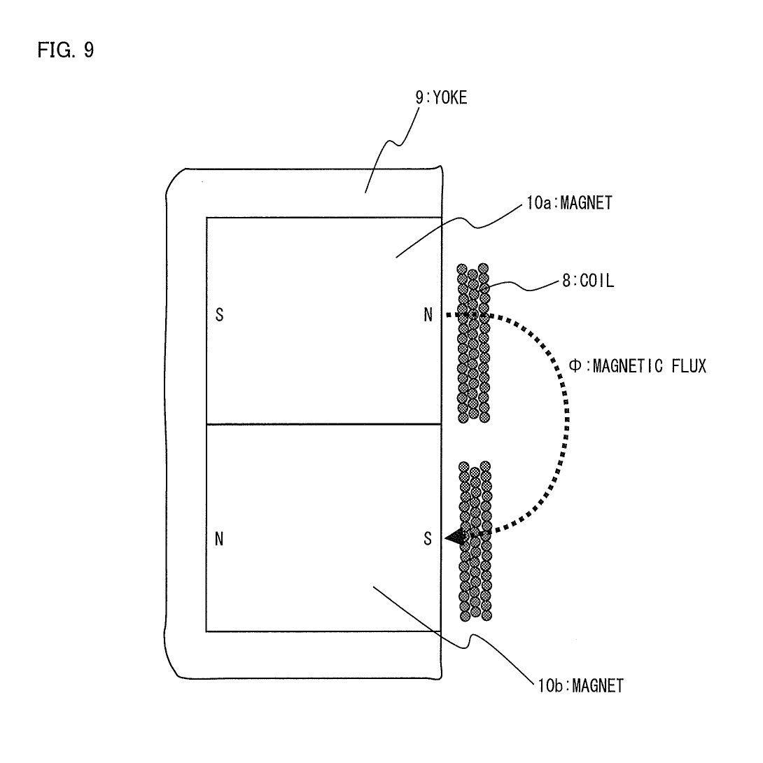

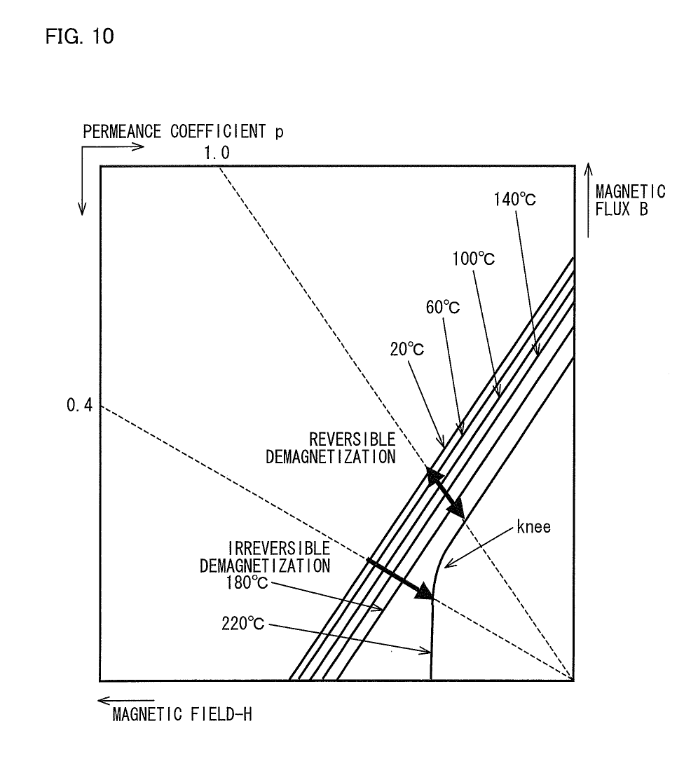

Next, a relationship between (i) a structure of a coil, a yoke, and magnets and (ii) adaptation to temperatures in a reflow environment is described with reference to FIGS. 8 through 10. FIG. 8 is a perspective view showing a positional relationship between magnets 10a and 10b, a yoke 9, and a coil 8 according to an embodiment of the present invention. FIG. 9 is a side view showing a positional relationship between magnets 10a 10b, a yoke 9, and a coil 8 according to an embodiment of the present invention. FIG. 10 is a graph for explaining a relationship between a demagnetization curve of a magnet and a permeance coefficient in an embodiment of a conventional invention and an embodiment of the present invention.

First, permanent demagnetization at a reflow temperature is explained with reference to FIG. 10. FIG. 10 shows a demagnetization curve of an ordinary magnet. As is clear from FIG. 10, the demagnetization curve has a temperature characteristic, and the magnetic flux density and the magnetic field tend to decline as the temperature rises.

A characteristic tendency in the example of FIG. 10 is the occurrence of a point of flexion (knee point), called knee, on the demagnetization curve at 220° C. The temperature at which and the position in which the knee occurs depend on the material and grade of the magnet.

In general, a Sm—Co-based magnet is unlikely to exhibit a point of flexion knee, and a NdFeB-based magnet is likely to exhibit a point of flexion knee. Further, a magnet with a smaller energy product is more likely to exhibit a lower magnetic flux density at the point of flexion knee.

In the case of a magnetic circuit configured with magnets, the permeance coefficient p, which depends on the structure, size, etc. of the magnetic circuit, is important. A point of intersection between a straight line drawn in accordance with the value of the permeance coefficient p and the demagnetization curve is a point of action of the magnet. If the magnet exhibits a sufficiently higher magnetic flux density at the point of action than at the point of flexion knee, the magnet is once demagnetized at a high temperature. However, because this demagnetization is highly reversible, the magnet returns substantially to its original state when the temperature drops.

On the other hand, if the magnet exhibits substantially the same magnetic flux density at the point of action as at the point of flexion knee, or if the magnet exhibits a lower magnetic flux density at the point of action than at the point of flexion knee, part of the magnet is irreversibly demagnetized at a high temperature. This leads to permanent demagnetization that prevents the magnet from regaining its original magnetic property even when the temperature drops. This causes deterioration in performance of the lens drive device.

There are various reflow conditions. In general, the magnet is exposed to an environment of approximately 230° C. to 260° C. for approximately ten seconds to several tens of seconds. For the prevention of the occurrence of permanent demagnetization at temperatures in a reflow environment, one way to adapt to reflow is to accurately select the material and grade of the magnet.

It should be noted here that a magnet capable of withstanding reflow generally becomes smaller in energy product to exhibit a low magnetic flux density at the point of flexion knee. For this reason, it can be said that such a magnet is low in magnetic-property-related performance in the first place (before it is placed in a high-temperature environment). One way to adapt to reflow is to design the magnetic circuit with a greater permeance coefficient p, separately from deterioration in performance due to a decrease in energy product, so that in a reflow environment the magnet exhibits a sufficiently higher magnetic flux density at the point of action than at the point of flexion knee.

The permeance coefficient p is expressed as:

p=(Lm/Am)*(Ag/Lg)*(σ/f),

where Lm is the thickness of the magnet, Am is the surface area of a pole face of the magnet, Ag is the cross-sectional area of the magnetic gap, Lg is the length of the magnetic gap, a is the leakage coefficient, and f is the coefficient of loss in magnetomotive force. When the pole face of the magnet is a magnetic gap face, Am=Ag. Therefore, for a greater permeance coefficient p, it is only necessary to increase the thickness Lm of the magnet or reduce the surface area Am of the pole face of the magnet.

As shown in FIG. 9, the present embodiment employs a bipolar magnet structure obtained by so putting magnets 10a and 10b on top of each other that different pole faces are disposed adjacent to each other. In the example of FIG. 9, the upper magnet 10a (first magnet part) has its north pole facing the coil 8, and the lower magnet 10b (second magnet part) has its south pole facing the coil 8 (different in polarity). Therefore, the magnetic flux Φ emanating from the magnet 10a travels from the north pole of the magnet 10a to the south pole of the magnet 10b and passes transversely across the coil 8 as indicated by a dotted line. Passage of an electric current through the coil 8 interlinked by the magnetic flux Φ causes electromagnetic force to be generated according to Fleming's left-hand law. In this example, the coil 8 is disposed in the movable part, with the yoke 9 and the magnets 10a and 10b disposed in the fixed part, so that passage of an electric current through the coil 8 causes the coil 8 to move.

The yoke 9, which is made of a magnetic body, is provided in contact with faces of the magnets 10a and 10b opposite those faces of the magnets 10a and 10b which face the coil 8, and is substantially U-shaped with its ends extending along a plane perpendicular to the optical axis. Such a structure allows a reduction in magnetic resistance of the magnetic circuit constituted by the coil 8, the yoke 9, and the magnets 10a and 10b, thus achieving an increase in permeance coefficient p. The permeance coefficient p can be increased to approximately 1.5, albeit depending on the dimensions of each separate member constituting the magnetic circuit.

It should be noted that in the case of a structure having a yoke disposed only on a back surface, instead of being U-shaped, with magnets not disposed bipolar, the permeance coefficient p is approximately 0.5 or less. Therefore, by employing such a magnetic circuit structure as shown in FIG. 9, the permeance coefficient p can be increased, and the occurrence of permanent demagnetization can be minimized even when such magnets 10a and 10b are used that a point of flexion knee occurs at a temperature in a reflow environment.

Meanwhile, in such a bipolar magnet structure as shown in FIG. 9, the coil 8 has a substantially elliptical shape with a hole, as shown in FIG. 8. In such a position as shown in FIG. 9, electric currents flows through the upper and lower portions of the coil 8 in opposite directions as indicated by arrows in FIG. 8, and the magnets 10a and 10b effects magnetic fluxes in opposite directions, so that electromagnetic force acts in the same direction both in the upper and lower portions of the coil 8. With the electric currents and magnetic fluxes in a state shown in FIG. 9, the coil 8 moves upward.

It should be noted that for adaptation to temperatures in a reflow environment, it is desirable that the coil 8 be wound directly on the lens holder 7 instead of being an air core coil. When the coil 8 used is a self-welding wire, its welding power is reduced by half at 120° C. to 130° C. That is, at reflow temperatures of 230° C. to 260° C., for example, the coiled wire loses most of its adhesive power. Therefore, an air core coil would get its coiled wire loosened. Therefore, when the coil 8 used is a self-welding wire, it is essential that the coil 8 be wound directly on the lens holder.

Further, use of solder for the process of forming terminals of the coil 8 may result in the solder being molten again at a reflow temperature. Special ways for reflow adaptation are needed in parts other than the magnets 10a and 10b, e.g., using, for reflow, solder having a lower melting temperature than the solder used for the process of forming the terminals, or using a conductive paste that hardens at a higher temperature than the reflow solder instead of using solder for the process of forming the terminals of the coil 8.

[Side Arrangements and Corner Arrangements]

In the foregoing description, the magnets 10a and 10b are planimetrically rectangular. However, camera modules of an embodiment of the present invention may use magnets 20 that are planimetrically triangular.

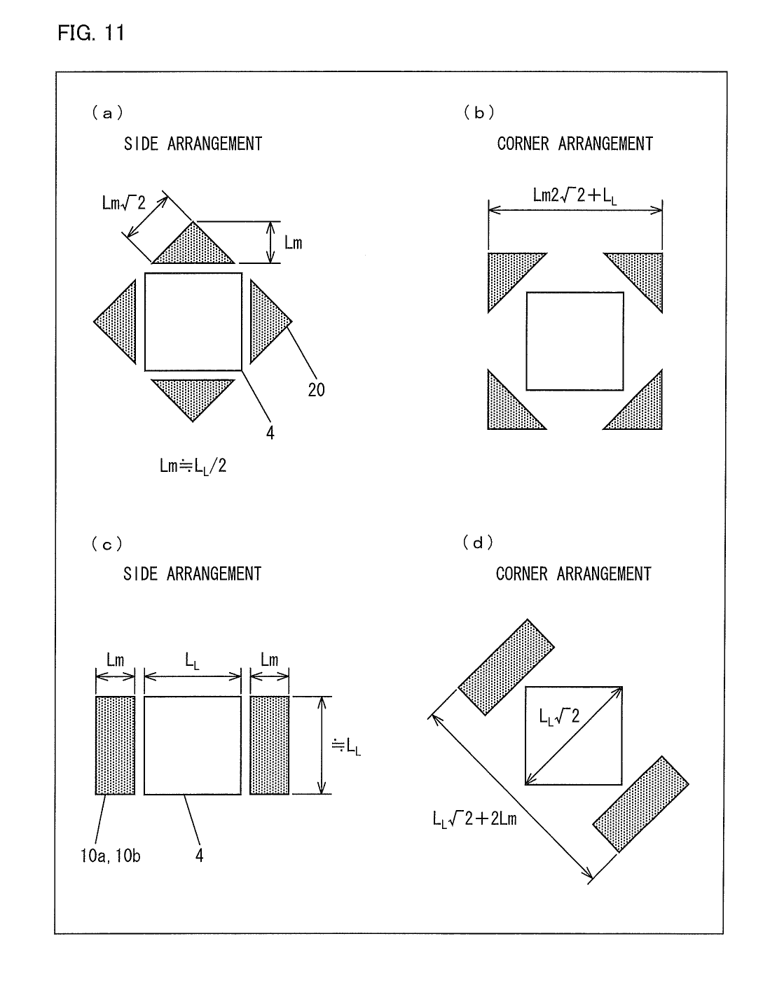

FIG. 11 explains arrangements of magnets in camera modules of an embodiment according to the present invention. (a) of FIG. 11 is a plan view showing the side arrangement of a planimetrically triangular magnet 20 along each side of a planimetrically rectangular image pickup lens 4 in a camera module of an embodiment of the present invention. L_{L} is the length of each side of the planimetrically rectangular image pickup lens 4.

(b) of FIG. 11 is a plan view showing the corner arrangement of planimetrically triangular magnets at the (four) corners of a planimetrically rectangular image pickup lens in a conventional camera module.

(c) of FIG. 11 is a plan view showing the side arrangement of planimetrically rectangular magnets 10a and 10b along a pair of opposite sides of a planimetrically rectangular image pickup lens 4 in a camera module of an embodiment of the present invention.

(d) of FIG. 11 is a plan view showing the corner arrangement of planimetrically rectangular magnets 10a and 10b at two opposite corners of a planimetrically rectangular image pickup lens 4 in a conventional camera module.

As for the dimensions shown in (a) through (d) of FIG. 11, the dimensions of gaps, etc. are omitted.

A comparison between (a) of FIG. 11 and (b) of FIG. 11 shows that the side arrangement of (a) of FIG. 11 can better reduce the size of a camera module than the corner arrangement of (b) of FIG. 11. Similarly, a comparison between (c) of FIG. 11 and (d) of FIG. 11 shows that the side arrangement of (c) of FIG. 11 can better reduce the size of a camera module than the corner arrangement of (d) of FIG. 11.

The planimetrically triangular magnet 20 has a thinner thickness at its outside edge than the thickness Lm at its apex and therefore is more likely to suffer from permanent demagnetization than the magnets 10a and 10b. However, such a planimetrically triangular magnet 20 can be used as shown in (a) of FIG. 11 by increasing the permeance coefficient p by appropriately designing the shapes and dimensions of the coils and yokes.

### Camera Module according to a Fifth Embodiment

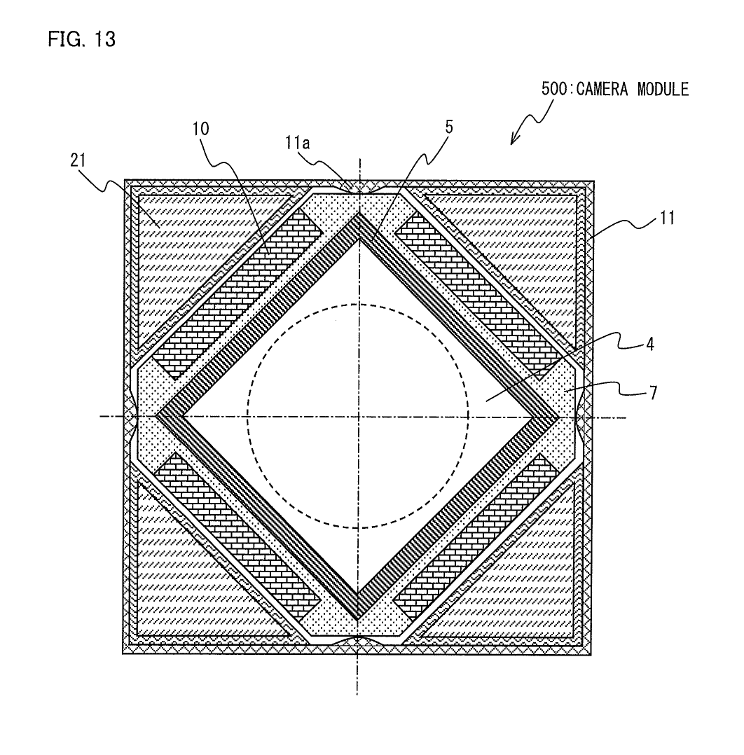

Next, still another embodiment of the present invention is described with reference to FIG. 13.

FIG. 13 is a plan view showing the shapes of an image pickup lens 4, a lens barrel 5, and a lens holder 7 in a camera module 500 of the present embodiment.

Each of the embodiments thus far described is configured to have coils disposed in the movable part and magnets disposed in the fixed part. On the other hand, the camera module 500 of FIG. 13 has magnets disposed in the movable part and coils and magnetic bodies disposed in the fixed part.

The configuration of FIG. 13 is similar to the configuration of Patent Literature 5 but different from the configuration of Patent Literature 5 in shape of the lenses mounted therein, thus proposing an arrangement of magnets, coils, etc. suitable for a rectangular lens.

As shown in the plan view of FIG. 13, the lens barrel 5 and the lens holder 7 are planimetrically rectangular (strictly speaking, the lens holder 7 is octagonal).

The camera module 500 of FIG. 13 has four planar magnets fixed to the lens holder 7, with triangular coils 8 fixed at the four corners of the camera module to face the magnets 10.

Each of the coils 8 has a magnetic body 21 provided in the middle, so that magnetic suction force is acting between the magnet 10 and the magnetic body 21. By passing an electric current through the coil 8 with such magnetic suction force acting, the lens holder 7 is rendered movable along the optical axis by the interaction between the magnet 10 and the coil 8.

As in Patent Literature 5, an example of a guide structure for supporting the lens holder 7 so that the lens holder 7 can move (is movable) along the optical axis is a guide constituted by protrusions 1 la protruding inward from the cover 11. However, the guide structure of the present invention is not limited to such a structure and may be configured as a guide using guide bars as in Patent Literature 6.

Such a configuration makes it possible to keep the lens holder 7 in position with use of magnetic suction force. Moreover, the synergistic action of the guide bars and the magnetic suction force causes frictional force to act between the movable part and the fixed part. This eliminates the need for conduction to the coil in a situation where there is no change in focal position, thus achieving lower power consumption.

By using, as the magnets, bond magnets disclosed in Japanese Patent Application Publication, Tokukaihei, No. 8-335508 A, the influence of thermal demagnetization of the magnets during reflow can be reduced.

A magnet such as a bond magnet contains a resin material for linking magnetic particles serving as a material for the magnet. For this reason, such a magnet is unavoidably lower in magnetic power (i.e., in energy product of the magnet) in comparison with a normal sintered magnet.

However use of a magnet such as a bond magnet in a structure capable of maintaining the position by magnetic suction force and frictional force even in the absence of conduction makes it possible to compensate for a drop in power (i.e., makes it possible to hold down total power consumption even with temporary passage of a large electric current).

It should be noted that the term “bond magnet” means a magnet obtained by crushing a magnet such as a ferrite magnet and kneading into rubber or plastic.

### Camera Module according to a Sixth Embodiment

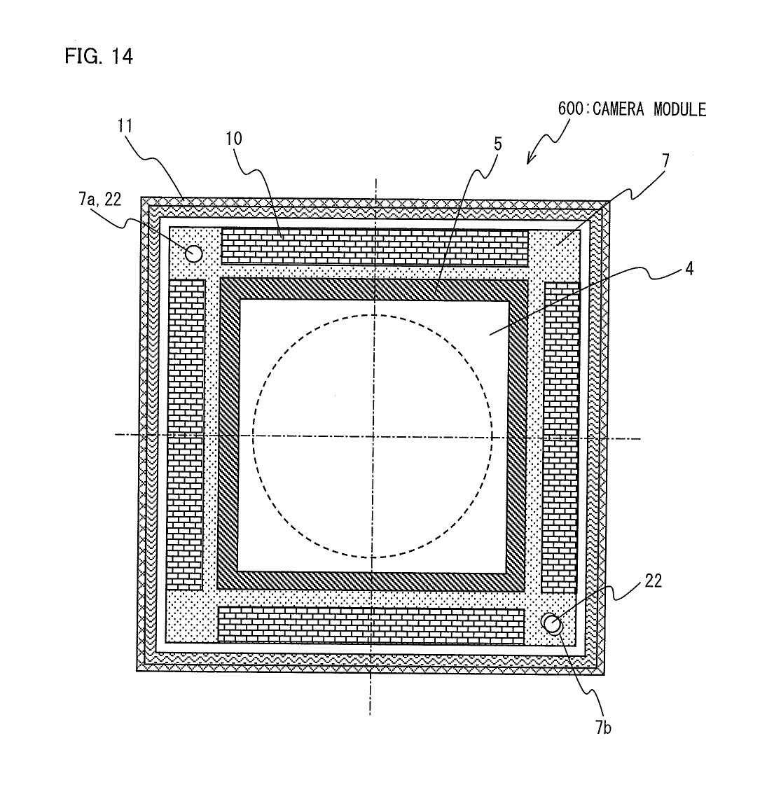

Next, still another embodiment of the present invention is described with reference to FIG. 14.

FIG. 14 is a plan view showing the shapes of an image pickup lens 4, a lens barrel 5, and a lens holder 7 in a camera module 600 of the present embodiment.

As with the camera module 500 of FIG. 13, the camera module 600 of FIG. 14 has magnets disposed in the movable part and a coil and a magnetic body disposed in the fixed part. The configuration of FIG. 14 is similar to the configuration of Patent Literature 6 but different from the configuration of Patent Literature 6 in shape of the lenses mounted therein, thus proposing an arrangement of magnets, a coil, etc. suitable for a rectangular lens.

As shown in the plan view of FIG. 14, the lens barrel 5 and the lens holder 7 are planimetrically rectangular. The lens module 600 of FIG. 14 has four planer magnets 10 fixed to the lens holder 7, with a rectangular coil 8 fixed over the entire inside surface of the cover 11 to face the magnets 10.

The cover 11 is constituted by a magnetic body, so that magnetic suction force is acting between the cover 11 and the magnets 10. By passing an electric current through the coil 8 with such magnetic suction force acting, the lens holder 7 is rendered movable along the optical axis by the interaction between the magnets 10 and the coil 8.

As a guide structure for supporting the lens holder 7 so that the lens holder 7 can move (is movable) along the optical axis, two guide bars 22 inserted through two holes 7a and 7b in the lens holder 7 are used, as in Patent Literature 6. However, the guide structure of the present invention is not limited to such a structure and may be otherwise configured.

Such a configuration makes it possible to keep the lens holder 7 in position with use of magnetic suction force. Moreover, the synergistic action of the guide bars 22 (guide section) and the magnetic suction force causes frictional force to act between the movable part and the fixed part. This eliminates the need for conduction to the coil in a situation where there is no change in focal position, thus achieving lower power consumption.

By using, as the magnets, bond magnets disclosed in Japanese Patent Application Publication, Tokukaihei, No. 8-335508 A, the influence of thermal demagnetization of the magnets during reflow can be reduced.

A magnet such as a bond magnet contains a resin material for linking magnetic particles serving as a material for the magnet. For this reason, such a magnet is unavoidably lower in magnetic power (i.e., in energy product of the magnet) in comparison with a normal sintered magnet.

However use of a magnet such as a bond magnet in a structure capable of maintaining the position by magnetic suction force and frictional force even in the absence of conduction makes it possible to compensate for a drop in power (i.e., makes it possible to hold down total power consumption even with temporary passage of a large electric current).

It should be noted that the term “bond magnet” means a magnet obtained by crushing a magnet such as a ferrite magnet and kneading into rubber or plastic.

The camera module may be configured such that the image pickup lens has a lens part that is planimetrically substantially circular and a flange part, formed to surround the lens part, whose outer perimeter is planimetrically rectangular; and the thickness of a site of the flange part at a midpoint of each of the four sides in the outer perimeter as viewed planimetrically is thinner than the thickness of each of the four corners of the flange part as viewed planimetrically.

This makes it possible to dispose the coil and magnet of the lens drive device in closer proximity to the lens part of the image pickup lens. This makes it possible to provide a camera module having a lens drive section with a smaller footprint.

Furthermore, the thickness of a site of the flange part at a midpoint of each of the four sides in the outer perimeter is narrower than the thickness of each of the four corners of the flange part. This makes it possible to make the magnet thicker to the extent that the thickness of the midpoint site is narrow and increase the permeance coefficient of the magnetic circuit. Accordingly, even if there is a decrease in magnetic flux density during reflow, the magnetic flux density can be kept greater than the magnetic flux density at the point of flexion knee on the demagnetization curve. This makes it possible to prevent deterioration in magnetic-property-related performance by preventing permanent demagnetization in thermal magnetization during reflow, thus providing a camera module adapted to temperatures in a reflow environment.

The camera module may be configured such that the magnet is constituted by first and second magnet parts put on top of each other; and a magnetic pole of the first magnet part that faces the coil and a magnetic pole of the second magnet part that faces the coil are different in polarity from each other.

In comparison with the case of a single magnetic pole facing the coil, the area of each single magnetic pole can be reduced by half, so that the permeance coefficient of the magnetic circuit can be increased. This makes it possible to alleviate the influence of permanent demagnetization in thermal magnetization during reflow.

The camera module may be configured to further include a yoke made of a magnetic body on faces of the first and second magnet parts opposite those faces of the first and second magnet parts which face the coil, wherein the yoke is substantially U-shaped with its ends extending along a plane perpendicular to the optical axis.

The inclusion of the yoke makes it possible to lower the magnetic resistance of the magnetic circuit constituted by the coil, the yoke, and the first and second magnet parts, thus making it possible to increase the permeance coefficient of the magnetic circuit and alleviate the influence of permanent demagnetization in thermal demagnetization during reflow.

The camera module may be configured such that the lens-retaining member is slidable inside of the holder section in which the lens-retaining member has been mounted.

By sliding the lens-retaining member inside of the holder section, the height of the lens-retaining member along the optical axis can be adjusted. Although, when the lens-retaining member is planimetrically rectangular, it is difficult to adjust with a screw the height of the lens-retaining member along the optical axis, the foregoing invention makes it possible to adjust the height of the lens-retaining member along the optical axis without providing a screw.

The camera module may be configured such that the lens-retaining member is fixed to the holder section after being positioned by slid inside of the holder section into contact with a height positioning jig.

By bringing the lens-retaining member, which is slidable, into contact with the height positioning jig, the lens-retaining member is positioned. Then, the lens-retaining section is fixed, with the lens-retaining section thus positioned. This makes it possible to position a rectangular lens with high precision without carrying out a focus adjustment step.

The camera module may be configured such that the lens drive section has a base member that forms a bottom surface facing the image pickup element; and the lens-retaining member is in contact with the base member.

The foregoing invention makes it only necessary to appropriately adjust the position in which the image pickup lens is mounted, thus eliminating the needs for a step of focus adjustment and achieving a reduction in processing cost.

Further, although, when the lens-retaining member is planimetrically rectangular, it is difficult to adjust with a screw the height of the lens-retaining member along the optical axis, the foregoing invention allows the position of the lens-retaining member along the optical axis to be determined with high precision without providing a screw.

The camera module may be configured such that the magnet and the coil are disposed only on each of the pair of opposite sides of the rectangular shape of the image pickup lens. This makes it possible to achieve a smaller footprint than in the case of an arrangement of magnets on four sides (two pairs of opposite sides).

The camera module may be configured such that the magnet is provided in the holder section; the coil is provided in the fixed part; and the fixed part has a magnetic body as part thereof.

This causes magnetic suction force to act between the magnet and the magnetic body, thus making it possible to retain the position of the holder section with use of the magnetic suction force. This eliminates the needs for conduction to the coil, thus achieving a reduction in power consumption.

Further, even when a low-power magnet is used for adaptation to reflow, a rise in power consumption can be suppressed.

The camera module may be configured to further include a guide section for supporting the holder section so that the holder section is movable along the optical axis.

According to the foregoing configuration, the synergistic action of the guide section and the magnetic suction force causes frictional force to act between the movable part of the lens drive section and the fixed part of the lens drive section. This eliminates the need for conduction to the coil in a situation where there is no change in focal position, thus achieving lower power consumption.

The camera module may be configured such that the magnet is a bond magnet. Use of a bond magnet makes it possible to reduce the influence of thermal demagnetization of a magnet during reflow.

The present invention is not limited to the description of the embodiments above, but may be altered by a skilled person within the scope of the claims. An embodiment based on a proper combination of technical means disclosed in different embodiments is encompassed in the technical scope of the present invention.

Further, although wafer-level lenses have been described as typical examples, this does not imply any limitation. Applications should be made to lenses formed into rectangular shapes by a technique such as dicing.

Industrial Applicability

Camera modules of the present invention, with smaller footprints and, furthermore, with consideration given to reflow adaptation, can be suitably used as camera modules that are mounted in various electronic devices including communication devices such as mobile terminals.

Reference Signs List
100, 200, 300, 400, 500, 600 Camera module
1 Optical section
2 Lens drive device (lens drive section)
3 Substrate section
4 Image pickup lens
4a Lens body (lens part)
4b Flange part
4c Outer perimeter
4d Inner perimeter
4m Site located at a midpoint
5 Lens barrel (lens-retaining member)
6 Image pickup element
7 Lens holder (holder section)
7a Protrusion
8 Coil (electromagnetic drive means)
9 Yoke (electromagnetic drive means)
10a, 10b Magnet (electromagnetic drive means)
10a Magnet (first magnet part)
10b Magnet (second magnet part)
11 Cover
12 Base
12a Raised portion
13 Opening
14 IR cut filter
15 Adhesive
20 Magnet
21 Magnetic body
22 Guide bar (guide section)
knee Point of flexion
p permeance coefficient

1. A camera module comprising:
an optical section having an image pickup lens and a lens-retaining member that retains the image pickup lens;
a lens drive section that moves the image pickup lens along an optical axis;
a holder section, contained in the lens drive section, which holds the lens-retaining member therein and which is movable along the optical axis with respect to a fixed part of the lens drive section;
an image pickup element that converts, into an electrical signal, light having entered the image pickup element through the image pickup lens; and
a substrate section on which the image pickup element has been mounted,
the lens drive section having electromagnetic drive means that drives the image pickup lens by electromagnetic force with use of a magnet and a coil,
the image pickup lens having a planimetrically rectangular shape,
the magnet and the coil being disposed along each of at least one pair of opposite sides of the rectangular shape.

2. The camera module as set forth in claim 1, wherein the image pickup lens has a lens part that is planimetrically substantially circular and a flange part, formed to surround the lens part, whose outer perimeter is planimetrically rectangular; and the thickness of a site of the flange part at a midpoint of each of the four sides in the outer perimeter as viewed planimetrically is thinner than the thickness of each of the four corners of the flange part as viewed planimetrically.

3. The camera module as set forth in claim 1, wherein the magnet is constituted by first and second magnet parts put on top of each other; and a magnetic pole of the first magnet part that faces the coil and a magnetic pole of the second magnet part that faces the coil are different in polarity from each other.

4. The camera module as set forth in claim 2, wherein the magnet is constituted by first and second magnet parts put on top of each other; and a magnetic pole of the first magnet part that faces the coil and a magnetic pole of the second magnet part that faces the coil are different in polarity from each other.

5. The camera module as set forth in claim 3, further comprising a yoke made of a magnetic body on faces of the first and second magnet parts opposite those faces of the first and second magnet parts which face the coil, wherein the yoke is substantially U-shaped with its ends extending along a plane perpendicular to the optical axis.

6. The camera module as set forth in claim 4, further comprising a yoke made of a magnetic body on faces of the first and second magnet parts opposite those faces of the first and second magnet parts which face the coil, wherein the yoke substantially U-shaped with its ends extending along a plane perpendicular to the optical axis.

7. The camera module as set forth in claim 1, wherein the lens-retaining member is slidable inside of the holder section in which the lens-retaining member has been mounted.

8. The camera module as set forth in claim 2, wherein the lens-retaining member is slidable inside of the holder section in which the lens-retaining member has been mounted.

9. The camera module as set forth in claim 7, wherein the lens-retaining member is fixed to the holder section after being positioned by being slid inside of the holder section into contact with a height positioning jig.

10. The camera module as set forth in claim 8, wherein the lens-retaining member is fixed to the holder section after being positioned by being slid inside of the holder section into contact with a height positioning jig.

11. The camera module as set forth in claim 1, wherein the lens drive section has a base member that forms a bottom surface facing the image pickup element; and the lens-retaining member is in contact with the base member.

12. The camera module as set forth in claim 2, wherein the lens drive section has a base member that forms a bottom surface facing the image pickup element; and the lens-retaining member is in contact with the base member.

13. The camera module as set forth in claim 1, wherein the magnet and the coil are disposed only on each of the pair of opposite sides of the rectangular shape of the image pickup lens.

14. The camera module as set forth in claim 2, wherein the magnet and the coil are disposed only on each of the pair of opposite sides of the rectangular shape of the image pickup lens.

15. The camera module as set forth in claim 1, wherein the magnet is provided in the holder section; the coil is provided in the fixed part; and the fixed part has a magnetic body as part thereof.

16. The camera module as set forth in claim 2, wherein the magnet is provided in the holder section; the coil is provided in the fixed part; and the fixed part has a magnetic body as part thereof.

17. The camera module as set forth in claim 15, further comprising a guide section for supporting the holder section so that the holder section is movable along the optical axis.

18. The camera module as set forth in claim 16, further comprising a guide section for supporting the holder section so that the holder section is movable along the optical axis.

19. The camera module as set forth in claim 15, wherein the magnet is a bond magnet.

20. The camera module as set forth in claim 17, wherein the magnet is a bond magnet.
